(19) United States
(12) Patent Application Publication
(10) Pub. No.: US 2026/0132803 A1
(43) Pub. Date: May 14, 2026

(54) PIVOT ACTUATOR

(71) Applicant: BAR-PNEUMATISCHE STEUERUNGSSYSTEME GMBH, Dattenberg (DE)

(72) Inventors: Markus KROLL, Dattenberg (DE); Axel KUHN, Niederbreitbach (DE)

(21) Appl. No.: 19/445,872

(22) Filed: Jan. 12, 2026

Related U.S. Application Data
(63) Continuation of application No. 18/370,254, filed on Sep. 19, 2023, now Pat. No. 12,523,242.
Application No. 18/370,254 is a continuation of application No. PCT/EP2022/055023, filed on Feb. 28, 2022.

(30) Foreign Application Priority Data
Mar. 19, 2021 (DE) 10 2021 106 889.4

(51) Int. Cl. F15B 15/06; F15B 15/24

(52) U.S. Cl. CPC F15B 15/06; F15B 15/24

(57) ABSTRACT

A pivot actuator (1), comprising: a housing (2); a piston (3) that is supported in the housing (2) and displaceable along a longitudinal axis (7) of the housing; a drive shaft (4) that protrudes from the housing (2) wherein the piston (3) engages the drive shaft (4) by form locking so that the drive shaft (4) is pivoted about a drive axis (8) by a pivot angle (10) to an end position through a displacement of the piston; and a switching cam (11, 26) that is fixed torque proof at the drive shaft (4) and configured to contact a stop element (5) at the housing (2) with a convex stop surface (18) at the switch element, wherein the end position is adjustable by an adjustment angle (25) about the drive axis (8) by displacing the stop element (5) along an adjustment axis (20) transversal to the drive axis (8), characterized in that the stop surface (18) follows an involute (22) of a circle (23) about the drive axis (8) wherein the involute is arranged in a direction transversal to the drive axis (8) so that the circle (23) is tangential to the adjustment axis (20).

The invention relates to a pivot actuator including a housing, a piston that is supported in the housing and displaceable along a longitudinal axis of the housing, a drive shaft that protrudes from the housing, wherein the piston engages the drive shaft by form locking so that the drive shaft is pivoted about a drive axis by a pivot angle to an end position through a displacement of the piston; and a switching cam that is fixed torque proof at the drive shaft and configured to contact a stop element at the housing with a convex contact surface of the switch cam in the end position, wherein the end position is adjustable by an adjustment angle by displacing the stop element along an adjustment axis that is oriented transversal to the drive axis.

A generic pneumatic pivot actuator is known e.g. under the product the designation “Keystone FIG. 89” by Emerson Electric Co. Saint Louis, MI/US. The known pivot actuator has a pivot angle of 90 degrees with two defined end positions that are adjustable by stop screws within an adjustment angle range of 10 degrees respectively. S-shaped contact surfaces contact end surfaces of the stop screws with partial surfaces of the S-shaped contact surfaces that extend transversal to the drive axis. An actuation angle of the known pivot actuator is limited by permissible positions of a contact point of the contact surface in the end surface of the contact screw that varies with the adjustment.

Pivot actuators are known in the art that have flat contact surfaces that are arranged at different angles relative to the drive axis after adjustment and that impact the end surfaces which can damage the contact screws.

### OBJECT

Thus, it is an object of the invention to increase the adjustment angle.

### SOLUTION

Improving upon the known pivot actuator it is proposed according to the invention that the contact surface follows an involute of a circle about the drive axis in a direction transversal to the drive axis wherein the circle contacts the adjustment axis. The involute designates a path of an end point of a line segment that is wound from a circumference of the circle and is always oriented perpendicular to the line segment.

Since the adjustment axis and the line segment are tangents to the circle the contact surface of the pivot actuator according to the invention always impacts the same contact point in the end surface of the contact element in a perpendicular direction. Thus, the adjustment angle is not limited by a size of the end surface but only by the installation space that is usable for the contact surface in a radial direction relative to the drive axis. Thus, a pivot actuator according to the invention can provide an adjustment angle of 25°, 30° or more.

Advantageously the adjustment angle of a pivot actuator according to the invention is adjustable by threading the stop element about the adjustment axis. Adjusting the adjustment angle by stop screws is proven and well known in the art. Further advantageously the stop screw is locked at the housing by a lock nut. Alternatively, the stop element can be fixed by clamping devices or by bonding through gluing or soldering at the housing.

Advantageously the switching cam includes a second stop surface in a pivot actuator according to the invention wherein the second stop surface contacts the second stop clement arranged at the housing in a second end position of the switching cam. This pivot actuator according to the invention facilitates an exact adjustment of two end positions of a valve, e.g; open and closed.

Advantageously the drive shaft of a pivot actuator according to the invention includes a teething that supports the switching cam torque proof. This couples a movement of the switching cam and of the drive shaft precisely during operations. On the other hand side, the switching cam which is a wear element can be replaced easily.

Advantageously the teething in the pivot actuator according to the invention is rotation symmetrical. Thus, the switching cam can be connected with the drive shaft in plural precisely defined positions. Further advantageously the teething is 8 times rotation symmetrical. A drive shaft of this type with involute teething is known from applicant's product line “agturn”.

A pivot actuator according to the invention can include spring elements between the housing and the piston that urge the piston into a neutral position in the range of the pivot angle. A pivot actuator of this type according to the invention reverts to a defined position should a failure occur.

Advantageously a pivot actuator according to the invention includes a pressure tight chamber that is defined by the piston and a fluid connection at the chamber, wherein the piston is displaceable by loading the fluid connection with a fluid. A pivot actuator of this type according to the invention can be driven hydraulically of pneumatically. Alternatively, a pivot actuator according to the invention can be driven electromagnetically or mechanically.

Advantageously a pivot actuator according to the invention includes a second pressure tight second chamber defined by the piston and a second fluid connection at the second chamber, wherein the piston is moveable back and forth by loading the second fluid connection. A position of this pivot actuator according to the invention is controllable by a pressure difference between the first fluid connection and the second fluid connection.

Advantageously a pivot actuator according to the invention includes a second piston that is moveable in the housing along the longitudinal axis wherein the second piston engages the drive shaft by form locking so that the drive shaft is pivoted relative to the first piston when the second piston is moved contrary to the first piston

The second piston compensates a bending load that is imparted by the first piston upon the drive shaft and causes a symmetrical force transmission between the piston and the drive shaft. Additionally, the second piston doubles an effective surface that transfers force from the fluid without significantly increasing a size of the pivot actuator. Alternatively, a simpler pivot actuator according to the invention can include only one piston.

Ferrous metals or non-ferrous metals and synthetic materials can be used for the switching cam depending on load conditions.

### EMBODIMENTS

The invention is subsequently described based on embodiments with reference to drawing figures, wherein:

FIG. 1 illustrates a pivot actuator according to the invention;

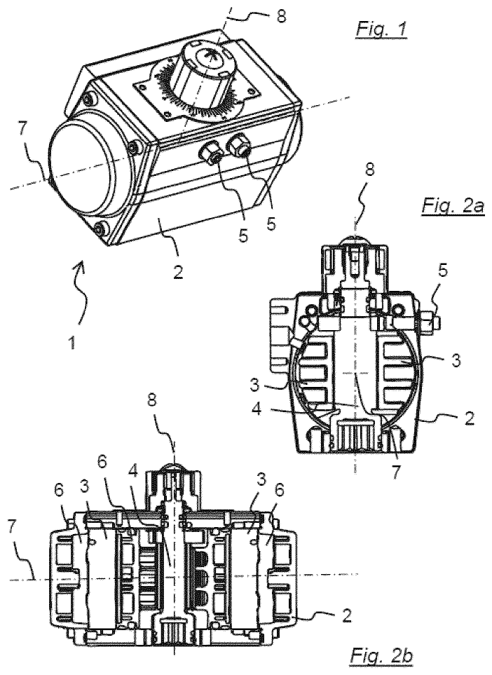

FIG. 2a/b illustrates two sectional views of the pivot actuator;

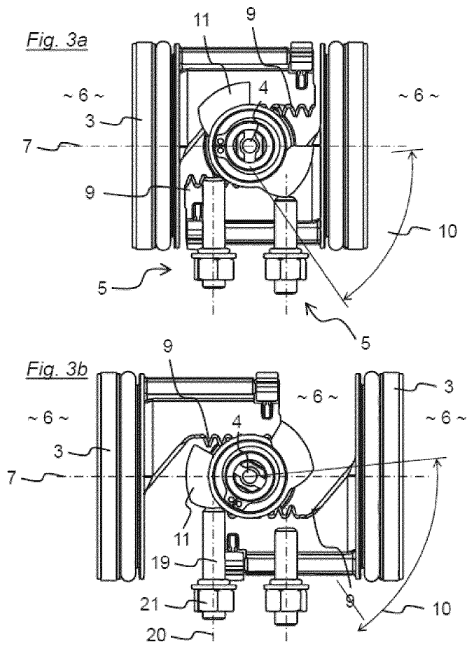

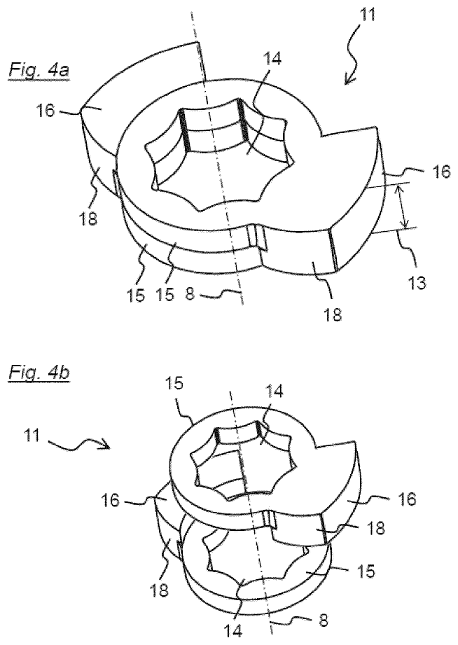

FIG. 3a/b illustrates an internal view of the pivot actuator in two end positions;

FIG. 4a illustrates a switching cam of the pivot actuator; and

FIG. 4b illustrates an exploded view of the switching cam.

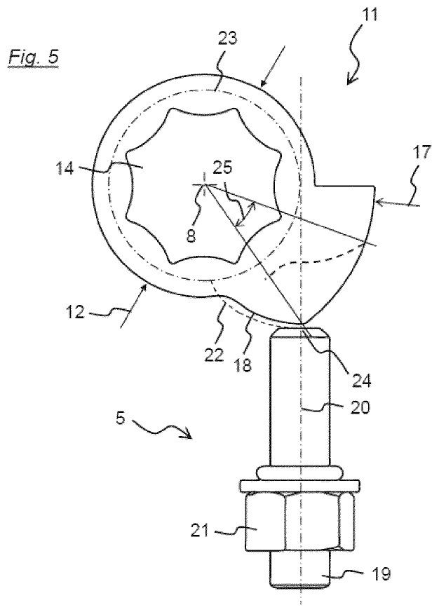

FIG. 5 illustrates a detail of the switching cam;

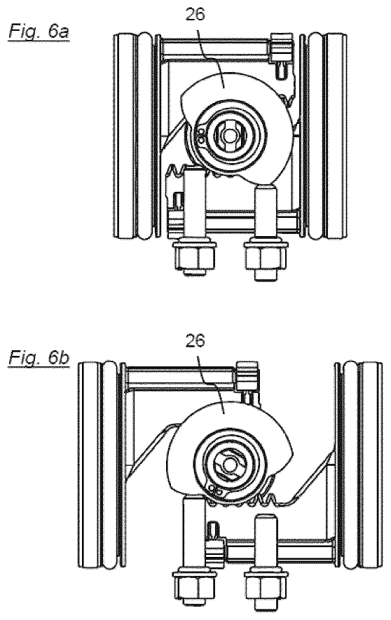

FIG. 6a, b illustrates an internal view of a second pivot actuator according to the invention; and

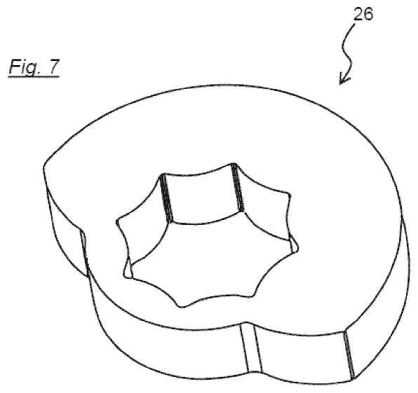

FIG. 7 illustrates the switching cam of the second pivot actuator.

The pivot actuator I according to the invention shown in FIGS. 1, 2a/b and 3a/b includes a housing 2, two pistons 3 included in the housing 2 and a drive shaft 4 that protrudes from the housing 2 and two stop elements 5.

The pistons 3 define one pressure tight chamber 6 between each other and two pressure tight chambers 6 in combination with the housing 2. The pistons 3 are displaceable in the housing 2 counteracting along a longitudinal axis 7 of the housing 2 and the driveshaft 4 is pivotable about a drive axis 8.

The pistons 3 and the driveshaft 4 include teethings 9 that engage each other by form locking. Loading the chamber 6 through non-illustrated pressure connections at the housing 2 with compressed air moves the pistons 3 and the drive shaft 4 is pivoted by the teethings 9 by a pivot angle 10 that is illustrated in FIG. 3a/b, between end positions of 0 degrees and 60 degrees.

A switching cam Il is attached at the drive axis 8 in the housing 2 and illustrated in detail in FIG. 4a/b, and 5. The switching cam 11 has a circular disc shaped base structure with a diameter 12 of 30 mm and a thickness 13 of 9 mm and includes an axial receiving opening 14. The receiving opening 14 is shaped as an eight pointed star with rounded corners that fixes the switching cam 11 on the drive shaft 4 through a longitudinal teething.

The switching cam 11 includes two identical discs 15 that are rotated relative to each other along the drive axis 8, that arc loosely placed on top of each other and made from the case-hardened material 1.0503/C45 respectively including a radial protrusion 16 that has a thickness of the switching cam 11 and a radius 17 of 24.5 mm. A respective contact surface 18 is configured at the protrusion.

The stop elements 5 respectively include a set screw 19 that is threaded into the housing 2 along an adjustment axis 20 and a lock nut 21 that locks the set screw 19 at the housing 2. The stop surface 18 follows an involute 22 about the circle 23 about the drive axis 8 wherein the circle 23 contacts the adjustment axis 20. Thus the contact point 24 in the stop surface 18 is arranged on the adjustment axis 20 in each permissible end position.

FIG. 5 illustrates the switching cam 11 in the maximum permissible end position and in dashed lines in the minimum permissible end position. The first pivot actuator 1 has a nominal pivot angle of 90 degrees. Limits for the end position adjustment for the 0 degree end position of the first pivot actuator 1 are at −5 degrees and +30 degrees, for the 90 degree end position the limits are at 60 degrees and 95 degrees. The adjustment angle 25 of the switching cam 11 between the limits of the end position adjustment is 35 degrees.

FIG. 6a/b show interior views of the end positions for a second pivot actuator according to the invention. The second pivot actuator corresponds to the first pivot actuator besides the switching cam 26 that is illustrated in detail in FIG. 7. Also the switching cam 26 of the second pivot actuator includes the basic structure and the receiving opening 14 of the switching cam 11 of the first pivot actuator 1, however the switching cam 26 of the second pivot actuator is not assembled from discs 15 but fabricated in one piece.

Two other advantageous pivot actuators differ from the first pivot actuator 1 according to the invention only in that one of the discs 15 is pivoted by 45 degrees or 90 degrees about the pivot axis compared to the first pivot actuator I according to the invention. The latter two pivot actuators thus have a nominal pivot angle of 135° or 180°.

### REFERENCE NUMERALS AND DESIGNATIONS

1 Pivot Actuator
2 Housing
3 Piston
4 Drive shaft
5 Stop element
6 Chamber
7 Longitudinal axis
8 Drive Axis
9 Teething
10 Pivot Angle
11 Switching Cam
12 Diameter
13 Thickness
14 Receiving Opening
15 Disc
16 Protrusion
17 Radius
18 Contact Surface
19 Set Screw
20 Adjustment Axis
21 Locking Nut
22 involute
23 circle
24 contact point
25 adjustment angle
26 switching cam

What is claimed is:

1-10. (canceled)

11. A pivot actuator, comprising:
a housing;
a piston movably disposed within the housing;
a drive shaft rotatably coupled to the housing, wherein the piston engages the drive shaft such that movement of the piston causes the drive shaft to pivot in a first direction about a drive axis within a first pivot angle to a first end position;
a first stop element configured to adjustably select the first end position; and
a switching cam configured to be coupled to and pivot with the drive shaft about the drive axis, the switching cam comprising a first stop surface configured to contact the first stop element to limit rotation of the drive shaft in the first direction about the drive axis to the first end position, wherein the first stop surface follows a first involute of a first circle about the drive axis of the drive shaft.

12. The pivot actuator of claim 11, wherein the first end position is adjustably selected by moving the first stop element along a first adjustment axis transversal to the drive axis, and wherein the first involute is arranged in a first direction transversal to the drive axis so that the first circle is tangential to the first adjustment axis.

13. The pivot actuator of claim 11, further comprising a second stop element configured to adjustably select a second end position;
wherein the piston engages the drive shaft such that movement of the piston along the longitudinal axis of the housing causes the drive shaft to pivot in a second direction about the drive axis within a second pivot angle to a second end position; and
wherein the first disc further includes a second stop surface fabricated as one piece with the first stop surface, the second stop surface configured to contact the second stop element to limit rotation of the drive shaft in the second direction about the drive axis to the second end position.

14. The pivot actuator of claim 13, wherein the second stop surface follows a second involute of a second circle about the drive axis of the drive shaft.

15. A pivot actuator, comprising:
a housing;
a piston movably disposed within the housing;
a drive shaft rotatably coupled to the housing, wherein the piston engages the drive shaft such that movement of the piston within the housing causes the drive shaft to pivot in a first direction about a drive axis within a first pivot angle to a first end position and to pivot in a second direction about the drive axis within a second pivot angle to a second end position;
a first stop element configured to adjustably select the first end position;
a second stop element configured to adjustably select the second end position;
a switching cam configured to be coupled to and pivot with the drive shaft about the drive axis, the switching cam comprising:
a first disc including:
a first base structure with a first thickness;
a first opening disposed within the first base structure, the first opening configured to receive a first portion of the drive shaft such that the first disc pivots with the drive shaft about the drive axis;
a first radial protrusion extending radially beyond the first base structure, the first radial protrusion having a second thickness that is larger than the first thickness and including a first stop surface configured to contact the first stop element to limit rotation of the drive shaft in the first direction about the drive axis to the first end position; and
a second disc including:
a second base structure with a third thickness;
a second opening disposed within the second base structure, the second opening configured to receive a second portion of the drive shaft such that the second disc pivots with the drive shaft about the drive axis;
a second radial protrusion extending radially beyond the second base structure, the second radial protrusion having a fourth thickness that is larger than the third thickness and including a second stop surface configured to contact the second stop element to limit rotation of the drive shaft in the second direction about the drive axis to the second end position.

16. The pivot actuator of claim 15, wherein the first disc and the second disc are offset along the drive axis.

17. The pivot actuator of claim 15, wherein an alignment of the first disc relative to the drive shaft is independent from an alignment of the second disc relative to the drive shaft.

18. The pivot actuator of claim 15,
wherein the second thickness and the fourth thickness are substantially the same; and
wherein a combination of the first thickness and third thickness is substantially the same as the second and the fourth thickness of the first and second radial protrusions.

19. The pivot actuator of claim 15, wherein the first and second discs are configured to be coupled to and nested along the drive shaft.

20. A pivot actuator, comprising:
a housing;
a piston movably disposed within the housing;
a drive shaft rotatably coupled to the housing, wherein the piston engages the drive shaft such that movement of the piston within the housing causes the drive shaft to pivot in a first direction about a drive axis within a first pivot angle to a first end position and to pivot in a second direction about the drive axis within a second pivot angle to a second end position;
a first stop element configured to adjustably select the first end position;
a second stop element configured to adjustably select the second end position;
a first disc configured to be coupled to the drive shaft in a first alignment relative to the drive shaft and pivot with the drive shaft about the drive axis, the first disc including a first stop surface configured to contact the first stop element to limit rotation of the drive shaft in the first direction about the drive axis to the first end position;
a second disc configured to be coupled to the drive shaft in a second alignment relative to the drive shaft and pivot with the drive shaft about the drive axis, the second disc including a second stop surface configured to contact the second stop element to limit rotation of the drive shaft in the second direction about the drive axis to the second end position; and
wherein the first disc and the second disc are configured to be coupled to the drive shaft such that the first alignment of the first disc relative to the drive shaft is independent from the second alignment of the second disc relative to the drive shaft.

21. A pivot actuator, comprising:
a housing;
a piston movably disposed within the housing;
a drive shaft rotatably coupled to the housing, wherein the piston engages the drive shaft such that movement of the piston within the housing causes the drive shaft to pivot in a first direction about a drive axis within a first pivot angle to a first end position and to pivot in a second direction about the drive axis within a second pivot angle to a second end position;
a first stop element configured to adjustably select the first end position;
a second stop element configured to adjustably select the second end position;
a circular disc shaped base structure with a diameter that is larger than a cross-section of the drive shaft;
an opening concentric with the center of the circular disc shaped base structure, the opening configured to receive a portion of the drive shaft such that the first disc pivots with the drive shaft about the drive axis;
a first stop surface extending radially beyond the diameter of the circular disc shaped base structure, the first stop surface configured to contact the first stop element to limit rotation of the drive shaft in the first direction about the drive axis to the first end position; and
a second stop surface fabricated as one piece with the first stop surface, the second stop surface extending radially beyond the diameter of the circular disc shaped base structure, the first stop surface and configured to contact the second stop element to limit rotation of the drive shaft in the second direction about the drive axis to the second end position.

22. A pivot actuator, comprising:
a housing;
a piston disposed within the housing and displaceable along a longitudinal axis of the housing;
a drive shaft rotatably coupled to the housing, wherein the piston engages the drive shaft such that movement of the piston within the housing causes the drive shaft to pivot in a first direction about a drive axis within a first pivot angle to a first end position;
a first stop element configured to adjustably select the first end position; and
a switching cam including an opening configured to slidably receive a portion of the drive shaft such that the switching cam rotates with the drive shaft about the drive axis, the switching cam including a first stop surface configured to contact the first stop element to limit rotation of the drive shaft in the first direction about the drive axis to the first end position.

23. The pivot actuator of claim 22, wherein the first stop surface follows a first involute of a first circle about the drive axis of the drive shaft.

24. The pivot actuator of claim 22, wherein at least a portion of the drive shaft includes longitudinal teething and wherein the opening includes multiple facets inversely corresponding to the longitudinal teething.

25. The pivot actuator of claim 24, wherein the opening is star shaped.

26. The pivot actuator of claim 24, wherein the multiple facets of the opening allow the switching cam to be aligned in multiple rotational orientations relative to the drive axis of the drive shaft.

27. The pivot actuator of claim 22, wherein the opening is disposed in a central region of the switching cam.

28. The pivot actuator of claim 22, wherein the first stop surface is disposed radially beyond the opening of the switching cam.

29. The pivot actuator of claim 22, wherein the switching cam is configured to be removably coupled to the drive shaft.

30. The pivot actuator of claim 22, wherein the switching cam is configured to slidably receive the drive shaft along the drive axis.
